(19) United States
(12) Patent Application Publication
(10) Pub. No.: US 2011/0255232 A1
(43) Pub. Date: Oct. 20, 2011

(54) Personal Information and Notebook Device

(76) Inventor: Fong-Ku LIU, Yonghe City (TW)

(21) Appl. No.: 12/189,180

(22) Filed: Aug. 10, 2008

(51) Int. Cl. G06F 1/16

(52) U.S. Cl. 361/679.27; 361/679.31

(57) ABSTRACT

A personal information and notebook device includes a volume, a writing part and a data storage-and-playing device. The volume can be folded and includes a first side and a second side, with an interior surface of the first side for installing the writing part formed by stacking plural pieces of paper, a body of the second side having a hollow part for latching and fixing a display panel of the data storage-and-playing device, and an interior of the body of the second side containing a space for placing control buttons, a battery and an operating circuit of the data storage-and-playing device. The device also includes a USB plug for downloading audio-video data from a computer. Therefore, in addition to providing a user for writing personal notes, the device can be used to listen to or check for music or information of the data storage-and-playing device.

### BACKGROUND OF THE INVENTION

a) Field of the Invention

The present invention relates to a personal information and notebook device, and more particularly to a device wherein a data storage-and-playing device is assembled with a writing part like a notebook, such that when a user is checking for audio-video information downloaded from a computer, he or she can always take down knowledge gained. In addition, the entire device is a type of a portable notebook, so as to facilitate taking notes at any time in a daily life.

b) Description of the Prior Art

A notebook helps people to take down what they see and know at any time, allowing the people to easily recollect fragments and knowledge at that time, and providing the people with convenience in induction and reflection to further collect into data and knowledge that are systematic and practicable.

Writing is one major feature for the notebook, and a variety of notebooks with different shapes and sizes are emerging on markets to fulfill needs for people of all kinds of ages and working styles. Moreover, in recent years, there is even a notebook which combines with a stationary like a perpetual calendar, a ruler or a pen, enabling the notebook to be more versatile and enriched.

However, as the conventional notebook is only equipped with the writing function, it will be too stiff and conservative as compared to population of an existing multimedia audio-video device, allowing a utilization of the notebook to be diminished gradually. In addition, it is a pity that modern people are almost unable to appreciate the collection and induction of knowledge by taking the notes personally, and rely exceedingly on using information devices such that they must carry heavy load when going out. Therefore, growth of bones of school kids will be affected, and if hand-writing or drawing equipment are needed, they are difficult to be widespread in the whole world as prices are very high.

### SUMMARY OF THE INVENTION

The primary object of the present invention is to provide a personal information and notebook device, wherein a notebook is assembled with a data storage-and-playing device, such that when a user is looking up electronic information (or electronic books), he or she can take down knowledge gained or make graphs intelligently by hands at any time, or when the user is writing notes, he or she can enjoy relaxation brought by a multimedia audio-video device at a same time, to promote release of a body and activity of a brain.

A second object of the present invention is to provide a personal information and notebook device, wherein a volume is provided with a writing part like a notebook at a first side, and a data storage-and-playing device at a second side for storing and playing multimedia audio-video information, with the first side and the second side being able to be folded toward each other, such that space will not be taken up by an entire size, and the volume can be carried for use easily and be protected.

A third object of the present invention is to provide a personal information and notebook device, wherein a body of the second side of the volume is provided with a hollow part to latch and fix a display panel of the data storage-and-playing device, and an interior of the body of the second side is provided with a space to contain control buttons, a battery and an operating circuit, with the control buttons being exposed or protruded out of a surface of the second side to facilitate operating and controlling by a user.

A fourth object of the present invention is to provide a personal information and notebook device, wherein the data storage-and-playing device is an MP3 player.

A fifth object of the present invention is to provide a personal information and notebook device, wherein a transmission wire is provided, with a surface of the transmission wire being in a flat-shape to serve as a bookmark of the writing part.

A sixth object of the present invention is provide a personal information and notebook device, wherein a size and dimension of the volume can be made as many types to fulfill needs of students, office workers or people at different ages; therefore, the volume can be made as a pocket type, a palm type or a book type, and can be also assembled with a perpetual calendar, a ruler or a calculator, so as to be more versatile and enriched.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of the present invention.

FIG. 2 shows a cutaway view of the present invention.

FIG. 3 shows a local cutaway view of the present invention.

FIG. 4 shows a schematic view of a second embodiment of the present invention.

### DETAILED DESCRIPTION OF THE PREFERRED EMBODIMENTS

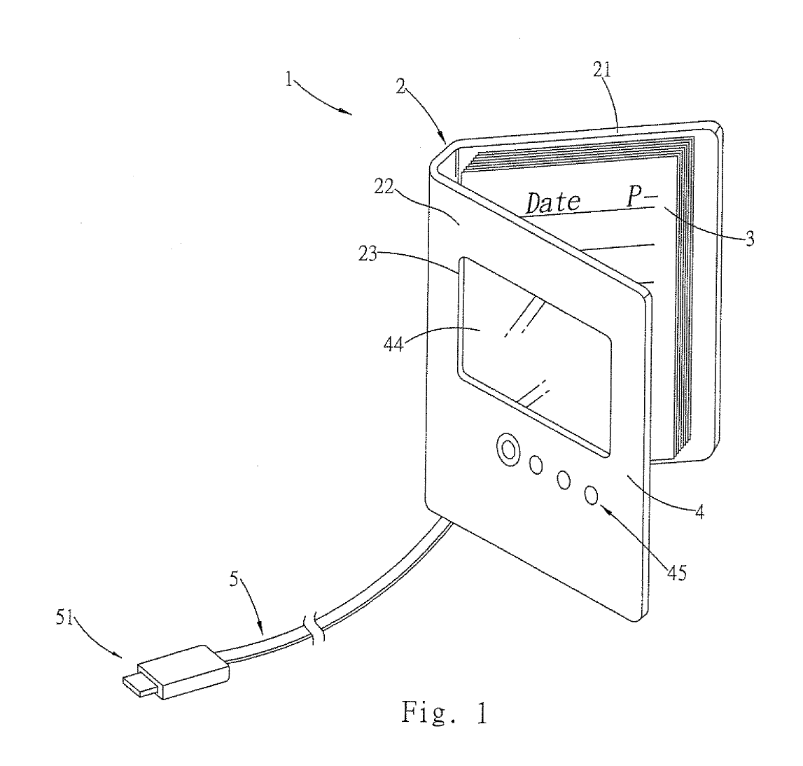

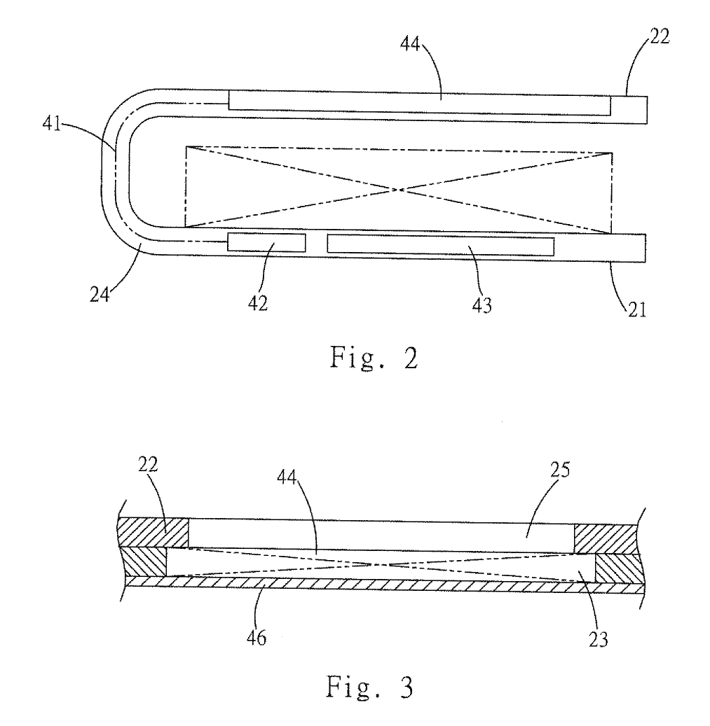

Referring to FIG. 1 and FIG. 2, a personal information and notebook device 1 of the present invention comprises a volume 2, a writing part 3 and a data storage-and-playing device 4, wherein the volume 2 can be folded and is provided with a first side 21 and a second side 22, with an interior surface of the first side 21 providing installation of the writing part 3, like a notebook, which is formed by stacking plural pieces of paper, such that a user can write on the writing part 3 after opening the volume 2; a body of the second side 22 of the volume 2 is provided with a hollow part 23, an interior of which is provided with a space 24 to connect with the interior of the first side 21, with the space 24 containing a lead wire 41, a battery 42 and an operating circuit 43 of the data storage-and-playing device 4, and a display panel 44 of the data storage-and-playing device 4 being able to be latched on the hollow part 23 to facilitate observing by the user.

Referring to FIG. 1, control buttons 45 of the data storage-and-playing device 4 are provided below the display panel 44, and can be protruded out of a surface of the volume 2 or hidden inside the volume 2. Ordinary MP3 operations, such as turning on and off, selecting music or adjusting speed, can be conducted through the control buttons 45.

Furthermore, a transmission wire 5 is provided and an end of the transmission wire 5 is provided with a USB (Universal Serial Bus) plug to facilitate downloading multimedia audio-video data from a computer.

Referring to FIG. 3, it shows a way that the display panel 44 is latched in the hollow part 23. A front end of the hollow part 23 is formed with a window 25, a frame surface of which is smaller than that of the hollow part 23, such that the user can observe data or information on the display panel 44 through the window 25. After the display panel 44 has been latched into the hollow part 23, an adhesive film 46 is attached on a back surface of the display panel 44 to fix the display panel 44 at the hollow part 23. The adhesive film 46 can be a heat dissipation film that is made by a heat conductive plastic material or a heat conductive metallic material, and can facilitate dissipating heat produced by the display panel 44 through heat conduction of the adhesive film 46.

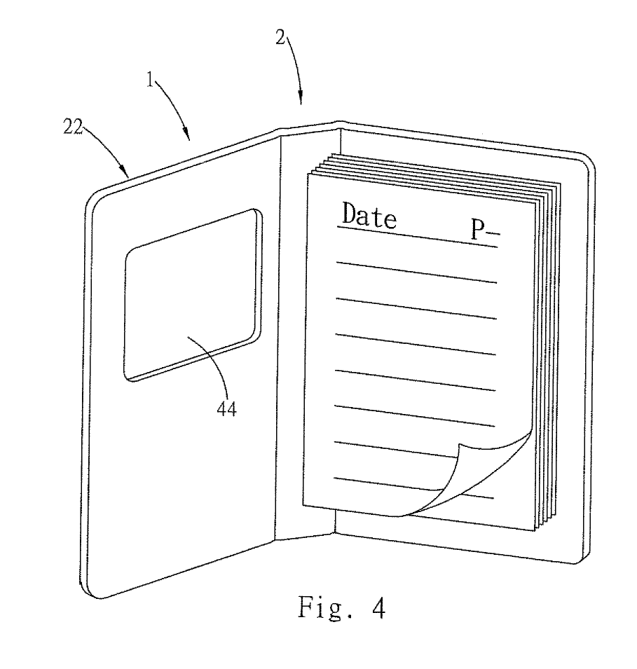

Referring to FIGS. 1 and 4, it shows a three-dimensional view of the present invention and a schematic view of another embodiment of the present invention. The display panel 44 can be also provided at an interior surface of the second side 22 of the volume 2; therefore, the user can only observe after opening the volume 2, or can observe or check for information at a same time when taking notes.

In implementation, an appearance of the transmission wire 5 can be configured as a flat shape to serve as a bookmark.

An interior of the aforementioned data storage-and-playing device 4 can be provided with a hard disk for storing multimedia data, and the audio-video data that is played can be an MPEG (Motion Picture Experts Group), a JPEG (Joint Photographic Experts Group) or an MJPEG (Motion Joint Photographic Experts Group), in addition to the MP3. In addition, the audio-video data can also correspond with an application of a memory card, such as an SD (Storage Device) card, an MMC (Multimedia Card) card, an MS (Memory Stick) card, an MS PRO (Memory Stick Professional) card or a CF (Compact Flash) Type I/II card, allowing the data storage-and-playing device 4 to be more functional.

The aforementioned transmission wire 5 includes a USB plug 51 which can be collected in and is clamped by an interlining (not shown in the drawings) of the volume 2, as well as can be used as a bookmark upon being pulled out.

Accordingly, for the personal information and notebook device, as the writing part like the notebook and the data storage-and-playing device are assembled to the volume which can be folded for collection, people are provided with full appreciation of writing the notes for collecting, inducting and memorizing, and at the same, with a capability of listing to music, under the conditions that the device does not taking up the space and is easy to carry for use.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A personal information and notebook device comprising a volume and a writing part, wherein a side of the volume is provided with the writing part, and the other side is provided with a data storage-and-playing device by which information is downloaded from a computer.

2. The personal information and notebook device according to claim 1, wherein the writing part includes pieces of paper or page leaves for writing.

3. The personal information and notebook device according to claim 1, wherein the data storage-and-playing device is an MP3 (MPEG Audio Layer III) player.

4. The personal information and notebook device according to claim 1, wherein the data storage-and-playing device includes a display panel and control buttons, and the volume is provided with a hollow part for latching the display panel.

5. The personal information and notebook device according to claim 4, wherein after latching the display panel into the hollow part, a side surface of the display panel is provided with a heat dissipation adhesive film.

6. The personal information and notebook device according to claim 5, wherein the heat dissipation adhesive film is made by a heat conductive plastic material or a heat conductive metallic material.

7. The personal information and notebook device according to claim 1, wherein a transmission wire is provided, with an end of the transmission wire connecting to the data storage-and-playing device, and the other end of the transmission wire being provided with a USB (Universal Serial Bus) plug to connect with a computer.

8. The personal information and notebook device according to claim 7, wherein the transmission wire is in a flat shape to serve as bookmark.
